(19) United States
(12) Patent Application Publication
(10) Pub. No.: US 2007/0273872 A1
(43) Pub. Date: Nov. 29, 2007

(54) Devices For Determining The Longitudinal And Angular Positions Of A Rotationally Symmetrical Apparatus

(76) Inventors: Ivan Vecerina, Lausanne (CH); Stephane Betrisey, Morges (CH); Jurjen Zoethout, Payeme (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/592,575

(22) PCT Filed: Mar. 8, 2005
(86) PCT No.: PCT/EP05/51031

§ 371 Date: Sep. 12, 2006

(30) Foreign Application Priority Data
Mar. 12, 2004 (EP) 04405147.2

(51) Int. Cl. G01B 11/26

(52) U.S. Cl. 356/153

(57) ABSTRACT

Devices are provided for determining the longitudinal and angular positions of a rotationally symmetrical apparatus, when guided inside an element surrounding the same is provided. In one implementation, a device is provided that comprises a bead held in motion-transmitting contact with the apparatus, and includes an imaging optical navigation sensor that measures the motion of the bead by comparing successive images of its outer surface. The bead may be made of a paramagnetic material. Further, the device may include a magnetic device for applying a magnetic force onto the bead to secure its contact with the apparatus. Additional features of the device may be used to identify the insertion and withdrawal of the apparatus in the device as they cause a displacement of the bead, therefore allowing the determination of the absolute position of the apparatus.

### TECHNICAL FIELD

The present invention relates to a device for determining the longitudinal and angular positions of a rotationally symmetrical apparatus used during simulated or real medical interventions, especially percutaneous interventions and, especially a device for measuring the motion of a rotationally symmetric apparatus using an optical navigation sensor.

More particularly, the present invention relates to an optical navigation sensor for indirectly tracking the motion of the surface of an instrument as it passes through a static element that surrounds it, such as an insertion sheath. The present invention furthermore relates to techniques that allow the identification of an inserted instrument or the determination of its absolute position, and to the tracking of particular instruments, such as wires of a small diameter.

### BACKGROUND ART

Surgery simulators, as well as computer assisted surgery systems and other applications, require or can benefit from a determination of the position of instruments manipulated by users. In minimally invasive or percutaneous procedures, where instruments usually pass through an insertion port such as a trocar or sheath, measuring the motion relative to such a surrounding structure can provide all or part of the information needed by a computer to either apply the effect of a user's gestures to a simulation model, or guide, assist or control the diagnostic or therapeutic procedure being performed. Other systems may rely on the same tracking device to otherwise process input from users who manipulate the tracked instruments, or to analyze the motion of the instruments.

Instrument tracking can either be based on absolute position measurements, or on continuous motion measurements starting from a known reference position. In the latter case, a means to establish the absolute position of the instrument is necessary initially, and eventually at regular intervals to compensate the accumulation of measurement errors. An absolute position measurement can be established. Such an initial reference position can be established by requesting that the user places the system in a defined state, by detecting the insertion of the instrument, or by detecting absolute position markers on its surface (as disclosed by the Applicant in WO 02071369 A).

Prior art discloses devices for tracking the relative motion of instruments, catheters, or other elongated instruments using a mechanical system that is in contact with the moving instrument.

Some systems use tracking wheels or a similar mechanism directly driven by cables or gears attached to the moving instrument. This allows a reliable measurement of the instrument's motion, but typically demands that the moving instrument be attached to the tracking device, preventing users from easily and completely withdrawing the instrument from the device.

In U.S. Pat. No. 3,304,434 and in U.S. Pat. No. 6,038,488 an arrangement is disclosed wherein a spherical object or sphere is in direct contact with the tracked surface. Driven by friction, the sphere rolls in place to follow the motion of the underlying surface. The motion of the sphere itself is then measured by two linear motion encoders driven by a pair of shafts mounted in tangential engagement with the sphere, in a force-transmitting contact. Each shaft then drives a coded wheel that reports the motion along an axis, providing tracking of each axis of motion.

Drawbacks of this approach include the friction imposed on the tracked instrument and the inertia of the mechanism, both of which can be felt by a user manipulating the tracked instrument. Also, slippage problems caused by an unreliable transmission of the instrument's motion to the spherical object can degrade the accuracy of the system. A spring-based mechanism is typically used to hold the bead in place, and further increases friction.

Other catheter-tracking devices, as described in EP 0970714 A, rely on a carriage assembly for holding a catheter between a pair of opposed pinch wheels. The carriage assembly rotates to rotate the said catheter about its longitudinal axis, and the pinch wheels rotate to translate the object axially. The inertia of this mechanism, however, perceptibly interferes with the free motion of the catheter.

In another invention, disclosed in U.S. Pat. No. 6,267,599, a framed assembly that includes rotation sensors is mounted on parallel guide rails. A motorized system ensures that this assembly follows the motion of the tip of an inserted instrument. Servo motors and force sensors are used to compensate for the friction and inertia of the system. Again, such systems fail to eliminate perceptible and disturbing haptic artifacts.

U.S. Pat. No. 6,323,837 discloses another measurement method for tracking the angular position of a rod or catheter used within the simulation of surgical operations. To measure the motion of the instrument, it uses two independent and orthogonal interfaces, composed of a driving wheel that drives the motion of a coded wheel—which is preferably a black coded transparent wheel with optical encoders as transducers to sense its rotation. A problem of this approach is the same friction which is used to drive each interface generates a resistance to the motion of the instrument in the other, orthogonal direction.

Another approach is to use a tight grid-like or striped marking of the instrument's surface, as described in WO 9810387. The device disclosed therein allows a contact-free reading of the motion of the instrument, but can only track specially designed surfaces. The tracked surface must be covered with a tight striped or grid-like pattern to allow motion detection. This increases manufacturing costs, and limits the type of instruments and surfaces that can be tracked. The surface coating is also often fragile: stains or scratches are likely to interfere with the tracking. Furthermore, the resolution that can be obtained with such a system is also limited.

The need remains, therefore, for a compact device that is able to conduct a precise measurement of the longitudinal and rotational, or angular, positions of an instrument without interfering with the manipulation of the instrument through excessive friction or inertia.

Optical tracking devices based on image capture and analysis, known as optical navigation sensors, have been introduced more recently. They have primarily been developed to improve the reliability and performance of computer mice (U.S. Pat. No. 5,578,813, U.S. Pat. No. 5,644,139, U.S. Pat. No. 6,256,016, U.S. Pat. No. 6,281,882). Unlike previous technologies which required a specific treatment or fabrication of the underlying surface (U.S. Pat. No. 4,409,479), these optical navigation sensors capture consecutive images of a moving surface and match each newly acquired image with translated copies of previous images. This allows the sensors to analyze and precisely measure the motion of a nearby surface without requiring any physical contact, thus allowing almost any type of surface to be tracked.

These sensors are used in particular to measure the displacement of devices along two orthogonal linear axes in a flat plane, as occurs within computer mice. The use of these sensors in different configurations have also been disclosed, for example to track the motion of a user's finger along 2 orthogonal axis (U.S. Pat. No. 6,057,540), as part of surface image scanning devices (U.S. Pat. No. 5,994,710), or within bar-code reading instruments (U.S. Pat. No. 6,585,158).

### DISCLOSURE OF THE INVENTION

The present invention aims at providing a device for reliably probing the motion of a rotationally symmetrical apparatus by optical tracking means.

The set purpose is met in accordance with the invention by means of a device in accordance with the wording of claim 1 using an optical navigation sensor to indirectly track the longitudinal motion and the rotation around a longitudinal axis of a rotationally symmetrical instrument.

More specifically, the features according to the present invention, consisting in tracking the surface of a small and lightweight spherical object firmly held in motion-transmitting contact with the apparatus, allow a low-friction and low-inertia position determination using an indirect measurement.

In comparison to a device that directly tracks the surface of the instrument, this device can effectively track a greater variety of surface materials, including dark, shiny, or transparent surfaces, as well as instruments of a very small diameter. Compared to other devices that measure the rotation of a spherical object held in motion-transmitting contact with the instrument, this invention relies on an approach that minimizes friction and inertia, by using a small spherical object that is tracked and pressed against the instrument using contact-free approaches.

Further preferred embodiments of the apparatus according to the invention are disclosed in the dependent claims.

A device for interfacing the movement of a rotationally symmetrical apparatus with a computer includes a support that allows two degrees of freedom and an optical navigation sensor. When a shaft is engaged with the support, it can move with two degrees of freedom while being held in contact with a motion-transmitting bead, where the optical navigation sensor senses each degree of freedom through the bead. The optical navigation sensor provides a simultaneous tracking of the combined longitudinal and rotational displacements of the apparatus.

An intermediate sphere, that is in motion-transmitting contact with the apparatus or instrument, is inserted between the tracked object and the optical navigation sensor to alleviate limitations of the latter, i.e. when the instrument is excessively small relative to the size of the image captured by the sensor or, when the surface properties of the instrument (such as excessive shininess or high light absorption) are incompatible with an image capture of sufficient quality.

The invention enhances the tracking of rotationally symmetrical instruments that move through a surrounding structure—which may be a dedicated insertion port such as a trocar or sheath, or another surrounding piece that is used as a reference for position measurements.

While not totally contact-free, such a device generates a very low friction and inertia.

Furthermore, the presence or absence of an inserted instrument can be detected through a displacement of the spherical object in or out of the image focus area of the optical navigation sensor.

Another object of the present disclosure is to describe how information that is obtained from the processing of images captured by the optical navigation sensor can be used as a means to establish the absolute longitudinal and rotational position of the instrument: by detecting the presence or absence of an instrument within the tracking device, or by detecting optical markings on the surface of the instrument according to a further embodiment of the invention. Additionally, the detection of surface markings can be used to identify the instrument. Another object of the invention is therefore to provide the possibility to readily recognize the presence of a simulated instrument and/or to determine the kind of the present simulated instrument and/or its absolute/reference position within the tracking device.

Still another object of the invention is to provide a device able to deliver information about the motion of an inner catheter being located inside an outer catheter or flexible element or instrument.

### BRIEF DESCRIPTION OF THE DRAWINGS

FIG. 1 shows the physical arrangement of an optical sensor and a spherical object (“the bead”) above the surface to be tracked according to an embodiment of the invention;

FIG. 2 shows the placement of a magnet used to improve the transmission of motion from the tracked surface to the intermediate bead, according to a preferred embodiment of the present invention;

FIG. 3 shows how the displacement of the bead can be used to detect the presence or absence of an inserted apparatus, whose surface is to be tracked;

FIG. 4 shows a mechanism that allows instruments of varying diameters to be tracked by the device according to the embodiment of FIG. 1;

FIG. 5 shows examples of images captured by an optical navigation sensor used for motion-tracking, and

FIG. 6 shows a schematic view of an instrument presenting a succession of colored segments, visible along the surface of an instrument.

### BEST MODE FOR CARRYING OUT THE INVENTION

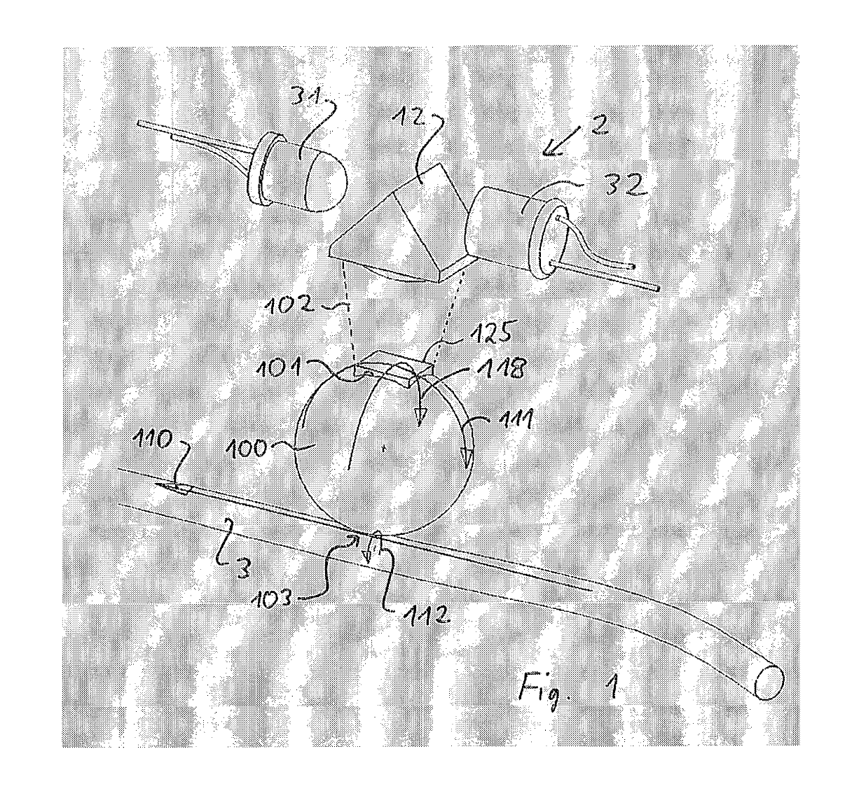

FIG. 1 shows a schematic view of a device using an optical navigation sensor 2 and a spherical object 100 (hereafter the “bead”) used to transmit information about the motion of an underlying surface point 103.

An instrument-holding device (not shown) comprises a bearing (not shown) for a bead 100 and an opening or transparent area through which a light-detecting and processing system such as an optical navigation sensor 2 can track the intermediate underlying surface 101 of the bead 100, seen within the image capturing volume 125.

The opening or transparent area within the instrument-holding device is at least as large as the maximum field of vision of the imaging optical navigation sensor 2, delimited by dotted lines 102.

The bead 100 is mounted for free rotation about all axes: it is held in place with minimal friction, so that it cannot displace itself or that only a motion away from the optical sensor 2 may be allowed, allowing the bead 100 to leave the intermediate image-capture zone 125.

The image capture volume 125 is delimited longitudinally by the depth of view defined by the optical element 12 and the relative position of the transducer 32. Surfaces that are closer to or further from the sensor 2 than the image capture volume will not be illuminated and imaged properly. Transversally, the image capture volume 125 is delimited by the area, within the depth of view, that is projected by optical element 12 onto the photosensitive area of transducer 32.

The instrument-holding device is connected with a refractive optical element 12 of the optical navigation sensor 2 in such a way that the bead 100, positioned underneath the sensor and in motion-transmitting contact with the instrument 3, is held at an adequate distance of the optical navigation sensor 2, so that the surface 101 of the bead 100 remains in focus for the image capture used for instrument tracking.

The point 103 of motion-transmitting contact, between the bead 100 and the surface to be tracked, is diametrically opposed to the bead area tracked by the optical sensor 2. Therefore, the motion of the tracked surface point 103 along the axes 110 and 112 is transmitted to the bead 100 by direct contact, and measured by the optical navigation sensor 2 as a displacement of the same magnitude along axes 111 and 118, respectively.

By using the bead 100 to capture and transmit the motion of the underlying object 3 to the optical sensor 2, the measuring unit can alleviate limitations of the optical navigation sensor and optical element 12. In particular:
the navigation sensor may fail to capture usable images of some excessively smooth, excessively shiny, or excessively dark (light-absorbing) surfaces. The bead's surface and texture can be chosen to ensure adequate tracking, and proper motion transmission from the instrument's surface regardless of its optical properties;
a tracked instrument may have an excessively small diameter, such that it is not large enough to be adequately imaged by the navigation sensor, or that it is too small to cover the image-capture area 125 of the latter. It is possible to correct this problem by developing a specially adapted optical element 12, or by inserting one or more lenses between the optical element 12 and the underlying surface. However, it can be more cost-effective to use an intermediate bead of adequate diameter to capture and transmit the motion of the instrument to the optical navigation sensor.

Specific implementations and features of this embodiment of the invention will be disclosed hereafter.

The correspondence of the surface motion recorded by the sensor and the instrument's motion is shown with arrows 110, 112, 111, 118. The surface motion axis reported by the optical navigation sensor 2, labelled with arrows 111 and 118, respectively measure the longitudinal translation and axial rotation of the bead.

The optical navigation sensor 2 comprises a light source 31 and a light-detecting and image-capturing transducer 32. The light source 31 can be a LED or another appropriate light emitting element. The transducer 32 can be a suitable array of photo detectors or e.g. a CCD device. The optical navigation sensor 2 optically detects motion by directly imaging as an array of pixels the various particular optical features visible in the image capture volume 125. The light from the light source 31 reflected from the surface 101 is focused onto the transducer 32 inside the optical navigation sensor 2. The responses of the individual photo detectors or CCD device are digitized to a suitable resolution and stored as a frame into corresponding locations within an array of memory. The image-capturing transducer 32 can be embedded within a chip that also includes a processor that processes the successive frames and continuously measures their relative displacement.

The 2-D optical navigation sensor 2 with integrated image processing can be composed of one of several existing devices, such as the ADNS-2001, ADNS-2030 or ADNS-2051 manufactured by Agilent Technologies. This sensor based on the processing of a sequence of captured images is mounted behind refractive and lens system 12, which focuses an image-capture grid to a certain distance from the sensor itself. A light emitting diode 31 is located nearby to ensure adequate illumination of the surface underneath the sensor.

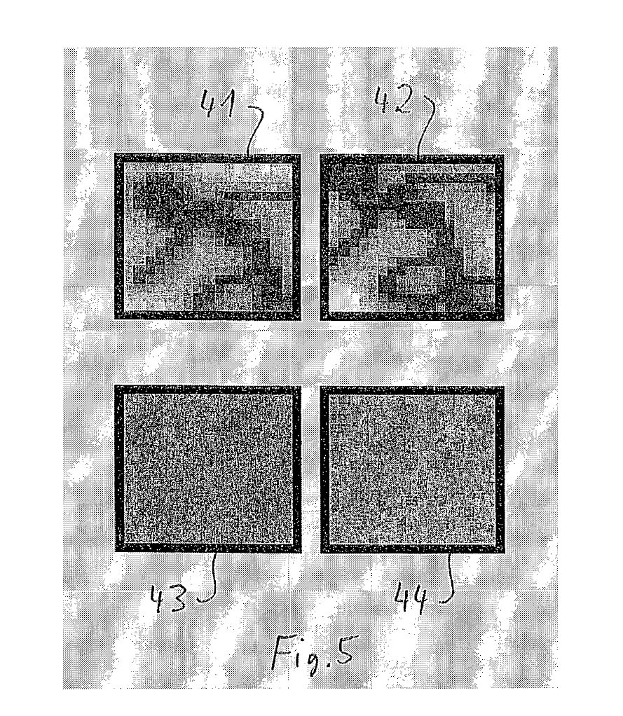

FIG. 5 shows examples of images captured by an optical navigation sensor for surface motion tracking, to illustrate how information is obtained from the images captured by the optical navigation sensor 2.

Images 41 and 42 show two consecutive images captured by the optical navigation sensor 2 used for tracking the surface of the bead. A comparison and matching of the initial image 41 (left) and the subsequent one 42 (right) allows to determine the magnitude and the direction of image displacement, which is proportional to the displacement of the tracked surface.

When the sensor is integrated in a device such as those described in this invention, this motion information can be translated into the longitudinal and rotational motion of the instrument 3. The image displacement is separated into a longitudinal component 111, parallel to the axis of the instrument 3, and a transverse component 118 orthogonal to the previous axis, both being scaled according to the resolution of the image and its scaling. The longitudinal component directly measures the longitudinal motion of the instrument through the tracking device; the transverse displacement of the instrument's surface is converted into a measure of the instrument's rotation relative to the tracking device, by dividing it by the radius of the instrument.

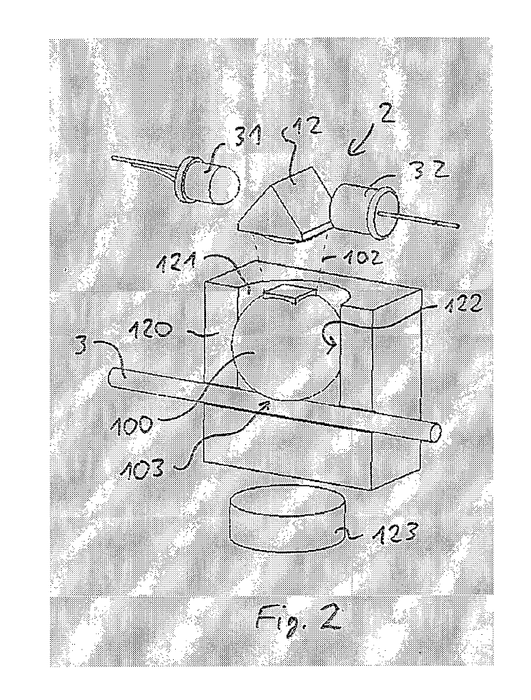

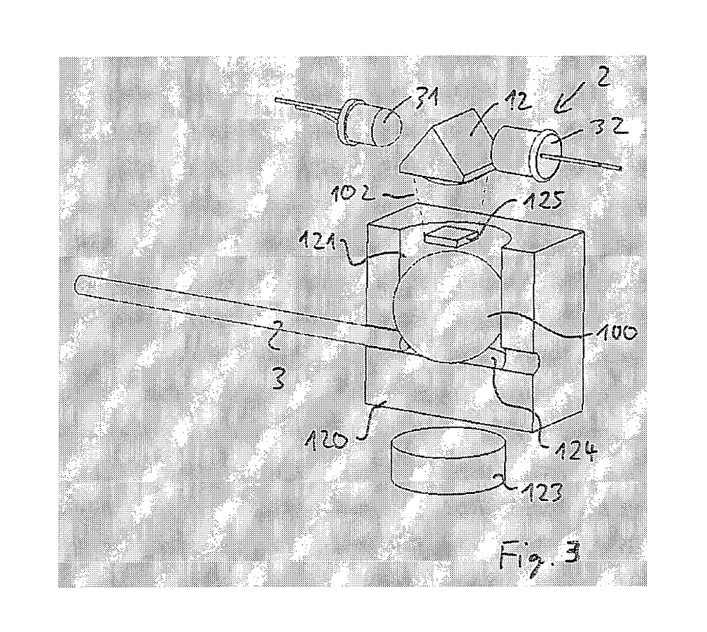

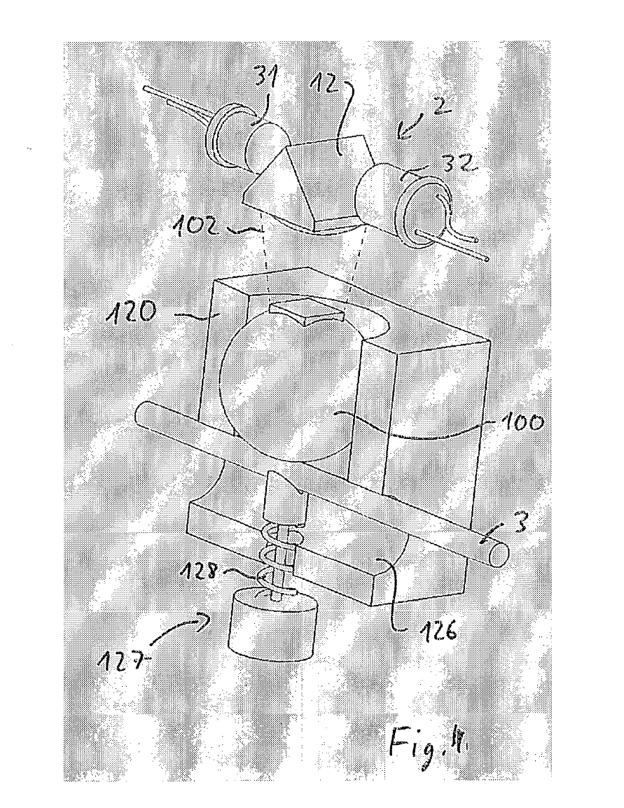

Images 43 and 44 show the difference that may typically be found between an image 43 (left) taken when no surface is visible in the image capture volume 125, and an image 44 (right) taken as the bead's surface has been brought in view within the image capture volume 125. The contrast between areas of the image increases in a way that can be detected. Under controlled and constant illumination, the luminosity of the image also typically increases. FIG. 2 and FIG. 3 illustrate how the insertion of an instrument can displace the bead in and out of the image capture volume 125. This displacement of the bead can be detected when the sensor successively reports images similar, first, to image 43 (=FIG. 3: bead out, no instrument inserted) and, then, to image 44 (=FIG. 4: bead in, instrument is present).

In an embodiment of this invention, that uses the ADNS-2051 optical navigation sensor, the following properties of the image captured by the optical navigation sensor are used:
1. a measure of the intensity of the light diffusely reflected by the surface, a.k.a. the brightness of the image (B);
2. the variability of the luminosity on different areas of the captured image, which is somewhat related to the contrast (C) of the image. On the ADNS-2051, a measure of the contrast (C) is available as a surface quality measurement (SQUAL register), and the overall image brightness (B) can be estimated by dividing the average pixel value by the shutter time (Average₁₃ Pixel/Shutter_Lower or Shutter_Upper). An increase of these two values indicates the situation depicted in image 44 and FIG. 4 (instrument inserted), while a decrease reflects the situation depicted in image 43 and FIG. 3 (no instrument inserted).

The transition between these two states therefore allows the detection of the passage of the instrument's tip in the device, which lifts the bead upon entry, and lets it move away upon exit. When this transition occurs, the absolute position of the instrument's tip is known—and can serve as a reference to subsequently determine the absolute position of the instrument from displacement measurements that are reported by the ADNS-2051 processor.

Optionally, a small-area optical reflective sensor, such as the HEDS-1100 manufactured by Agilent Technologies, may be added to the device to measure the luminosity of a single point on the surface of the instrument itself with a high accuracy. Such an optical reflective sensor is a fully integrated module containing a LED emitter and a matched IC photo detector in one housing. A bifurcated aspheric lens is used to image the active areas of the emitter and the detector to one single spot. This device can be used to detect optical markings on the surface of the instrument, such as colored segments of distinct colors.

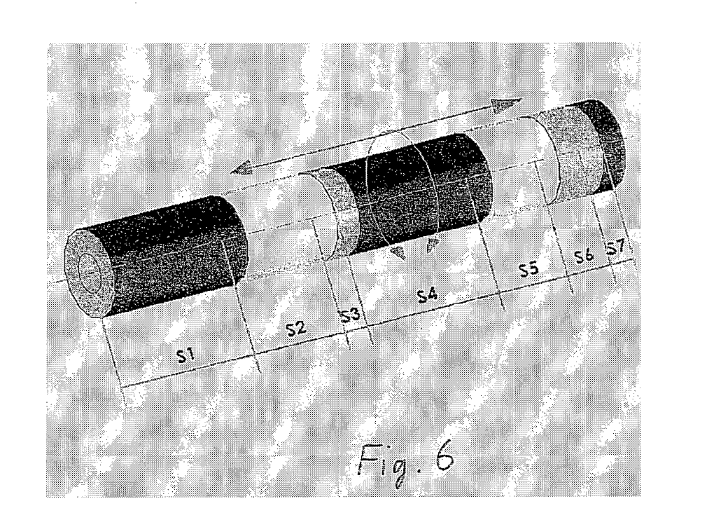

FIG. 6 shows a schematic view of an instrument 3 made of a succession of colored, shaded or differently textured segments, that may also be painted or engraved. While measuring the motion of the instrument, the separate small-area optical reflective sensor can be queried about the luminosity of the surface it is sensing. The distinctly shaded areas can therefore be detected as they pass underneath the imaging optical navigation sensor 2, and the length of each segment can be measured during the longitudinal motion of the instrument (in the direction 21 labelled with an X axis). The resulting pattern of segment colors and lengths (e.g. black-S1, white-S2, grey-S3, black-S4, white-S5, grey-S6 and black-S7) can be used to encode information. This information can be used as a unique signature for each instrument, thus providing for automated instrument identification as it is inserted, or to identify a specific area along the length of the instrument.

In particular, this information can be used to establish the absolute position of the tracked instrument within the device, as a transition between two colored segments, uniquely identified by their shade or length, is detected. This absolute position can serve as a reference to subsequently determine the absolute position of the instrument from displacement measurements that are reported by the ADNS-2051 processor. For having an example of such an optical reflective sensor or its method of implementation, the one skilled in the art may consider the disclosure of EP application No 03405694 filed on Sep. 22, 2003 (corresponding to U.S. Ser. No. 10/946.684 filed on Sep. 22, 2004) in the name of the Applicant and the teaching of which is incorporated herein by reference.

In FIG. 1, the bead 100 can have a diameter below 1 cm, while the section of the inserted instrument 3 may have any diameter, going down to a fraction of a millimeter. For example, some guidewires used in medical procedures have a diameter of 0.3 mm, which is smaller than the area imaged by the optical navigation sensor and optical elements commonly found on the market.

Because the bead 100 has a small size and mass, its inertia remains very low, and the friction forces that are transmitted to the moving apparatus can remain imperceptible.

One or more optical navigation sensors 2 could be used to track the motion of the bead 100, and other sensor locations could be chosen, but tracking the bead motion in a location that is diametrically opposed to where the bead 100 is in contact with the tracked surface is optimal for an optical navigation sensor, and simplifies calculations. The longitudinal movement of the underlying object 3 is shown with arrow 110 being translated into the rotary movement 111 of the bead 100. The rotary movement of the underlying object 3 is shown with arrow 112 being translated into the rotary movement 118 of the bead 100.

FIG. 2 shows details of an embodiment according to FIG. 1 of the invention applied to the tracking of a rotationally symmetrical, small-diameter apparatus 3, such as a catheter or guidewire used in a real or simulated medical intervention.

The body 120 of the device (the front half of which has been removed in this view) is traversed by a tubular cavity, through which an instrument 3 can be inserted and moved freely. The bead 100 is located inside a cylindrical well 121 drilled within the body, perpendicular to said cavity guiding the apparatus 3. Obviously, the well may be of a different shape suited for the intended purpose, such as prismatic or conical.

An optical navigation sensor 2, attached to the top of the well 121, measures the rotation of the bead 100. As the motion of the instrument 3 drives the rotation of the bead 100, the surface displacement measured by the optical sensor 2 directly corresponds (same magnitude, but opposite direction) to the displacement of the instrument's surface at the point of contact 103 with the bead 100—as described in FIG. 1.

For the bead 100 to reliably follow the instrument's motion, the friction force between the bead 100 and instrument at contact point 103 needs to be more important than the friction at the contact zone 122 between the bead 100 and the walls of the well 121. If the device is oriented so that the bead 100 is vertically above the catheter, gravity alone may ensure that the bead 100 moves with the instrument.

However, a force is preferably applied on the bead 100 to reliably generate adequate contact pressure between the bead 100 and the moving instrument 3, because of the small mass and size of the bead 100. In a preferred embodiment, the bead 100 is at least partly made of a paramagnetic material, and a permanent magnet or an electromagnet 123 is used to passively, respectively actively, pull the bead 100 towards the instrument 3. This ensures that the bead 100 reliably follows the motion of the inserted instrument 3, and that the device can function in any orientation, independently of gravity, and without any additional contact or friction on the bead.

This magnetic system allows to keep the friction and inertia of the tracking device as low as possible.

FIG. 3, to be compared to FIG. 2, demonstrates how the device can detect the insertion of a catheter. When no instrument is inserted, as shown in FIG. 3, the bead 100 sits further from the optical sensor, pulled away by the magnet 123 used to attract the bead 100 towards the instrument insertion cavity.

The bead 100 overlaps the instrument-insertion cavity 124, and is beyond the image capturing volume and focus depth 125 of the image capturing system embedded in the optical navigation sensor 2.

FIG. 2 shows the bead's position after the insertion of an instrument 3: the inserted instrument 3 has lifted the bead 100, which is now in-focus for adequate imaging and tracking by the optical navigation sensor 2.

Referring back to FIG. 5, images 43 and 44 reflect the picture that would be captured by the imaging sensor in the situation illustrated in FIG. 3 and in FIG. 2, respectively.

As explained for the embodiment of FIG. 1 and 5, the optical navigation sensor provides output signals that reflect the sharpness and quality of the image captured by the optical navigation sensor 2. The displacement of the bead 100, triggered by the insertion (FIG. 2) or withdrawal (FIG. 3) of an instrument 3, can therefore be detected and reported by the tracking device.

FIG. 4 shows an embodiment of the invention that allows instruments 3 of various diameters to be inserted within the tracking device.

The tracking system presents the same components described in FIG. 2 and 3, but in this embodiment the instrument-insertion cavity 126 includes a mechanism 127 that allows the tracking of a wider range of instrument diameters. The bottom of the cavity 126 includes a mobile centering device 127 that pushes the inserted instrument 3 towards the optical sensor 2, with a force slightly higher than the pressure that the bead 100 exercises on an inserted instrument 3. The concave shape of the cavity bottom 126, on a section transversal to the axis of the instrument 3, ensures that an inserted catheter is properly centered, in addition to being lifted up against the tracking bead 100.

To allow the insertion of the instrument 3, the centering device 127 may be lifted by an active mechanism only when the system detects, by a separate means (such as, for example, an optical sensor as previously mentioned), that an instrument 3 has been inserted. Alternatively, the centering device 127 may be passively lifted by a spring-based 128 mechanism.

By measuring the position of the centering device 127, the diameter of an inserted instrument 3 can be determined. This diameter value is used in the computation of the instrument's rotation angle from the transversal displacement measured by the optical device, as described above.

The device according to the FIG. 1 to 4 shows the application of the optical navigation sensor 2, combined with the use of a motion-transmitting bead 100, to the analysis of an instrument's motion through a surrounding static element 120. This device can track various rigid or flexible instruments 3, including catheters and guidewires, such as those used for medical interventions, as well as during procedures simulated for training.

The key benefits of the device according to FIG. 1 to 4 is its ability to track the longitudinal and rotational motion of rotationally symmetrical instruments 3 that have an arbitrary diameter, and an arbitrary surface quality, including very thin metallic guidewires that could not directly be tracked by an optical navigation sensor 2. This is achieved while keeping the friction and inertia of the system very low, making them nearly imperceptible to a user manipulating an inserted instrument. It has also been demonstrated that the presence or absence of an inserted instrument can also be established through the displacement of the bead.

Another embodiment not shown in the Fig. and providing information about the longitudinal and rotational motion of an e.g. outer catheter and an inner catheter provided in the outer catheter is based on the teaching of this application. Said rotationally symmetrical apparatus 3 is a transparent first rotationally symmetrical apparatus 3. The transparency is to be provided in all parts which may pass, following a longitudinal and rotational motion of the catheter 3, in the vicinity of the optical navigation sensor. Inside said first apparatus 3 is a second inner rotationally symmetrical apparatus, which can be seen from outside the first apparatus 3. Therefore a second light source and a second image-capturing and processing device is provided, wherein light emitted by said second light source is directed directly on the outer surface of the second rotationally symmetrical apparatus. The surface equivalent to surface 101 is in this case on the inner catheter. Reflected light from said surface is detected by said second light detector to produce a position signal showing a locally varying distribution in the longitudinal direction and in the peripheral direction to enable a relative position and angular measurement for the inner catheter, such a method being similar to those disclosed in the previously mentioned patent application by the Applicant (EP 03405694). This embodiment necessitates a greater diameter of the inner catheter so said the image surface of the second light source has sufficient dimensions to allow the measurement, even through the transparent outer device. In this embodiment the bead 100 is not only used to allow the magnification of the image but to provide a reflective surface, the surface of the outer catheter itself being transparent.

It is also possible to provide two or more devices according to FIG. 1 at different longitudinal places of the apparatus 3. It is then preferred to use a control unit connected to the output of both sensors. In this way occasional slippage occurring at one navigation sensor can be detected and corrected. For instance, the system could rely on the sensor that reports the largest motion.

1. A device for determining longitudinal and angular positions of a rotationally symmetrical apparatus guided inside a surrounding element, comprising at least one light source for emitting light within the surrounding element and at least one light-detecting and processing system intended to produce signals representative of the longitudinal and angular positions of the apparatus.
wherein the device further comprising a spherical object arranged within the surrounding element and in motion-transmitting contact with the rotationally symmetrical apparatus,
wherein the emitted light being directed onto an outer surface of the spherical object by which it is reflected, the light-detecting and processing system being arranged so as to detect at least part of the reflected light,
the spherical object being at least partly made of paramagnetic material, and
the device further comprising a magnetic device intended to produce a magnetic field at least in a region of the spherical object to secure motion-transmitting contact between the latter and the rotationally symmetrical apparatus.

2. A device for determining longitudinal and angular positions of a rotationally symmetrical apparatus guided inside a surrounding element, comprising at least one light source for emitting light within the surrounding element and at least one light-detecting and processing system intended to produce signals representative of the longitudinal and angular positions of the apparatus,
the device further comprising a spherical object arranged within the surrounding element and in motion-transmitting contact with the rotationally symmetrical apparatus,
the emitted light being directed onto an outer surface of the spherical object by which it is reflected, the light-detecting and processing system being arranged so as to detect at least part of the reflected light,
the device further comprising a focusing optical element defining an image capturing volume, for the light-detecting and processing system, into which the outer surface of the spherical object is able to be translated, substantially upon implementation of contact between the apparatus and the spherical object, and
the light-detecting and processing system being further arranged so as to be able to detect a difference between a first image corresponding to an absence of the outer surface of the spherical object within the image capturing volume and a second image corresponding to a presence of the outer surface of the spherical object within the image capturing volume.

3. A device according to claim 1, further comprising a focusing optical element defining an image capturing volume, for the light-detecting and processing system, into which the outer surface of the spherical object is able to be translated, substantially upon implementation of contact between said the apparatus and the spherical object,
the light-detecting and processing system being further arranged so as to be able to detect a difference between a first image corresponding to an absence of the outer surface of the spherical object within the image capturing volume and a second image corresponding to a presence of the outer surface of the spherical object within the image capturing volume.

4. A device according to any of claims 1, the determination of longitudinal and angular positions of the rotationally symmetrical apparatus being implemented by comparison of at least two consecutive images captured within the image-capture volume.

5. A device according to claim 1, wherein the device is adapted for determining longitudinal and angular positions of an instrument used in a real or in a simulated medical intervention.

6. A device according to claim 1, further comprising at least one additional optical sensor to directly track a small area of the apparatus.

7. A device according to claim 6, wherein the device includes computing means to identify the nature of the apparatus on the basis of small area tracking.

8. A device according to claim 6, wherein the device includes computing means to identify the nature of the apparatus on the basis of small area tracking in combination with the results of the determination of longitudinal and angular positions over time.

9. A device according to claim 2, further comprising a well within which said the spherical object is arranged and able to translate upon implementation of contact between the spherical object and the apparatus.

10. A device according to claim 1 further comprising an adaptation mechanism to accommodate rotationally symmetrical apparatuses of different diameters, a detection system to detect the diameter of a given rotationally symmetrical apparatus inserted inside the surrounding element, and; calculating means to compute the diameter in connection with the light-detecting and processing system signals to determine an angular position of the rotationally symmetrical apparatus.

11. A device according to claim 1, for determining longitudinal and angular positions of a first transparent rotationally symmetrical apparatus, including an additional light source for emitting light within the surrounding element, in a direction of a second inner rotationally symmetrical apparatus by which it is reflected, the second inner rotationally symmetrical apparatus being able to move longitudinally and angularly inside and with respect to the first transparent rotationally symmetrical apparatus, the device including an additional light-detecting and processing system to detect the reflected light and compute longitudinal and angular positions of the second inner apparatus on the basis of the detection.

12. A device according to claim 3, the determination of longitudinal and angular positions of the rotationally symmetrical apparatus being implemented by comparison of at least two consecutive Images captured within the image-capture volume.

13. A device according to claim 2, wherein the device is adapted for determining longitudinal and angular positions of an instrument used in a real or in a simulated medical intervention.

14. A device according to claim 3, wherein the device is adapted for determining longitudinal and angular positions of an instrument used in a real or in a simulated medical intervention.

15. A device according to claim 2, further comprising at least one additional optical sensor to directly track a small area of the apparatus.

16. A device according to claim 15, wherein the device includes computing means to identify the nature of the apparatus on the basis of small area tracking.

17. A device according to claim 15, wherein the device includes computing means to identify the nature of the apparatus on the basis of small area tracking in combination with the results of the determination of longitudinal and angular positions over time.

18. A device according to claim 3, further comprising a well within which the spherical object is arranged and able to translate upon implementation of contact between the spherical object and the apparatus.

19. A device according to claim 2, further comprising an adjustment mechanism to accommodate rotationally symmetrical apparatuses of different diameters, a detection system to detect the diameter of a given rotationally symmetrical apparatus inserted inside the surrounding element, and calculating means to compute the diameter in connection with the light-detecting and processing system signals to determine an angular position of the rotationally symmetrical apparatus.

20. A device according to claim 2, for determining longitudinal and angular positions of a first transparent rotationally symmetrical apparatus, including an additional light source for emitting light within the surrounding element, in a direction of a second inner rotationally symmetrical apparatus by which it is reflected, the second inner rotationally symmetrical apparatus being able to move longitudinally and angularly inside and with respect to the first transparent rotationally symmetrical apparatus, the device including an additional light-detecting and processing system to detect the reflected light and compute longitudinal and angular positions of the second inner apparatus on the basis of the detection.
